(19) United States
(12) Patent Application Publication
(10) Pub. No.: US 2013/0022459 A1
(43) Pub. Date: Jan. 24, 2013

(54) SEALS FOR REDUCING LEAKAGE IN ROTARY MACHINES

(71) Applicants: Omprakash Samudrala, Clifton Park, NY (US); Christopher Edward Wolfe, Niskayuna, NY (US); Raymond Edward Chupp, Simpsonville, SC (US)

(72) Inventors: Omprakash Samudrala, Clifton Park, NY (US); Christopher Edward Wolfe, Niskayuna, NY (US); Raymond Edward Chupp, Simpsonville, SC (US)

(73) Assignee: GENERAL ELECTRIC COMPANY, SCHENECTADY, NY (US)

(21) Appl. No.: 13/184,592

(22) Filed: Jul. 18, 2011

(51) Int. Cl. F01D 25/00; F01D 11/02; F16J 15/16; F01D 11/00; F16J 15/44; F16J 15/447

(52) U.S. Cl. 415/230; 277/355; 277/416; 277/543; 277/414; 277/415; 277/301

(57) ABSTRACT

A seal assembly for a rotary machine is provided. The seal assembly includes multiple sealing device segments disposed intermediate to a stationary housing and a rotor. Each of the segments includes at least one plate and a sealing element. The seal assembly also includes multiple inter-segment gaps formed between the multiple sealing device segments. Further, for each pair of adjacent sealing device segments, at least one pair of adjacent plates includes one plate overlapping another plate at an inter-segment gap.

### BACKGROUND

The invention relates generally to seals for reducing leakage and more particularly to a sealing assembly for reducing leakages between inter-segment gaps in a rotary machine.

Generally a variety of seals are used in industrial rotary machines such as gas turbines to control the amount of cooling or purge air flowing through clearances between a rotor and a stator. For example, a brush seal having a rotor contact element such as a bristle pack, is used for providing a tight clearance. However, the bristle pack can undergo severe wear due to interference between the bristles and the rotor caused by thermal transients during turbine start up or shut down. This wear accumulates over time, thereby reducing the leakage performance of the seal during steady state operation. On the other hand, a retractable brush seal eliminates or reduces seal wear due to thermal interference during start up or shut down by physically moving the seal away from the rotor. The retractable brush seal may be actuated passively by means of leaf springs that respond to the varying pressure differential across the seal during turbine start up or shut down. The retractable brush seal is assembled in a high clearance position, and, as the pressure differential across the rotary machine builds up (during start up), the leaf springs deform moving the seal closer to the rotor. Similarly, during shutdown, the falling pressure differential across the seal causes the leaf springs to retract, moving the seal away from the rotor. This mechanism eliminates bristle/rotor interference that might otherwise occur during start up and shut down and sustains the seal leakage performance over its operating life.

However, this type of retractable brush seal experiences leakage through inter-segment gaps, which can be especially large when in the high clearance position. Even during steady state operation, when the seal is in its low clearance position, the inter-segment gap leakage can be up to one-third of the total seal leakage. Excessive leakages lead to loss in engine performance due to increased secondary flows.

Accordingly, it would be desirable to reduce leakages between the inter-segment gaps of the seal assembly in the rotary machine.

### BRIEF DESCRIPTION

In accordance with an embodiment of the invention, a seal assembly for a rotary machine is provided. The seal assembly includes multiple sealing device segments disposed intermediate to a stationary housing and a rotor. Each of the segments includes at least one plate and a sealing element. The seal assembly also includes multiple inter-segment gaps formed between the multiple sealing device segments. Further, for pairs of adjacent sealing device segments, at least one of a pair adjacent plates includes one plate overlapping another plate at a respective inter-segment gap.

In accordance with an embodiment of the invention, a method of reducing leakage in a rotary machine is provided. The method includes obtaining multiple sealing device segments, wherein each of the segments comprises at least one plate and a sealing element. The method also includes disposing the multiple sealing device segments on the rotary machine such that a tortuous flow path is created at inter-segment gaps due to overlapping of pairs of adjacent plates at each respective inter-segment gap.

In accordance with an embodiment of the invention, a rotary machine is provided. The rotary machine includes stationary housing extending circumferentially around a rotor rotatable about an axis. The rotary machine also includes a seal assembly having multiple sealing device segments disposed intermediate to the stationary housing and the rotor. Each of the segments includes at least one plate and a sealing element. The rotary machine further includes multiple inter-segment gaps formed between the multiple sealing device segments. For pairs of adjacent sealing device segments, at least one of a pair adjacent plates includes one plate overlapping another plate at a respective inter-segment gap.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a rotary machine in accordance with an embodiment of the present invention.

FIG. 2 is a cross-sectional view of a turbine section of the rotary machine in accordance with an embodiment of the present invention.

FIG. 3 is a perspective view of a seal assembly of the rotary machine in accordance with an embodiment of the present invention.

FIG. 4 is another perspective view of a seal assembly of a rotary machine in an open seal position in accordance with an embodiment of the present invention.

FIG. 5 shows another perspective view of a seal assembly of a rotary machine in a closed seal position in accordance with an embodiment of the present invention.

FIG. 6 is a perspective view of a seal assembly of the rotary machine in accordance with another embodiment of the present invention.

FIG. 7 is a perspective view of a seal assembly having an intermediate plate without the sealing element in the rotary machine in accordance with an embodiment of the present invention.

FIG. 8 is flow chart of a method of reducing leakage in a rotary machine in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

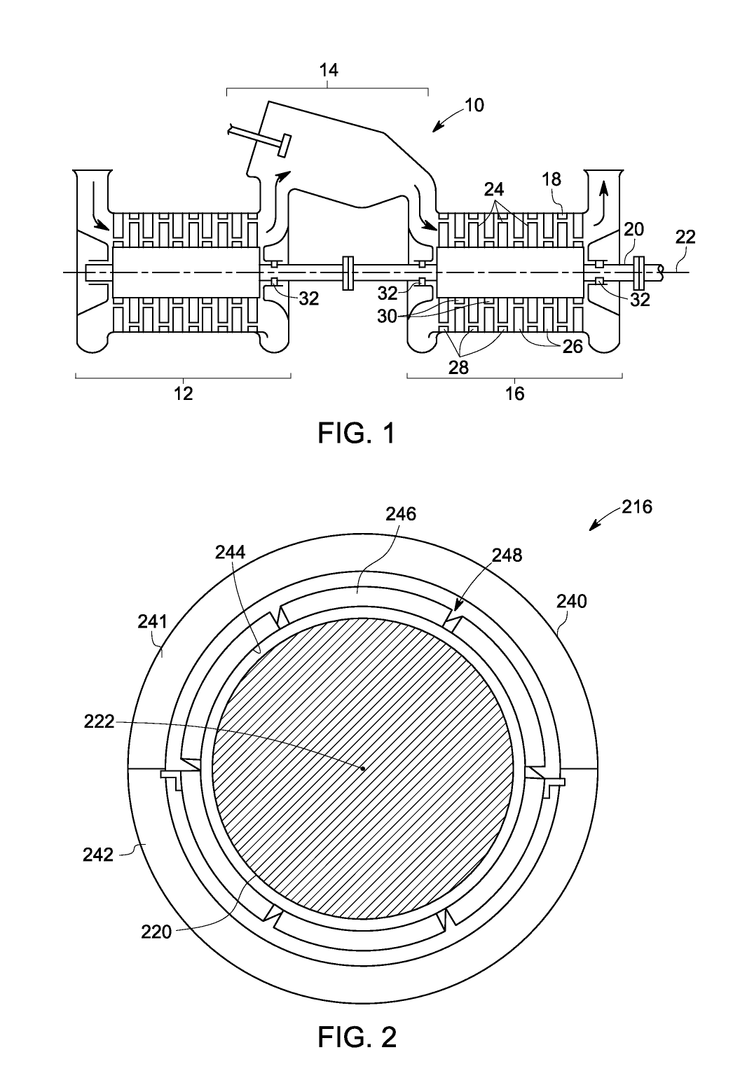

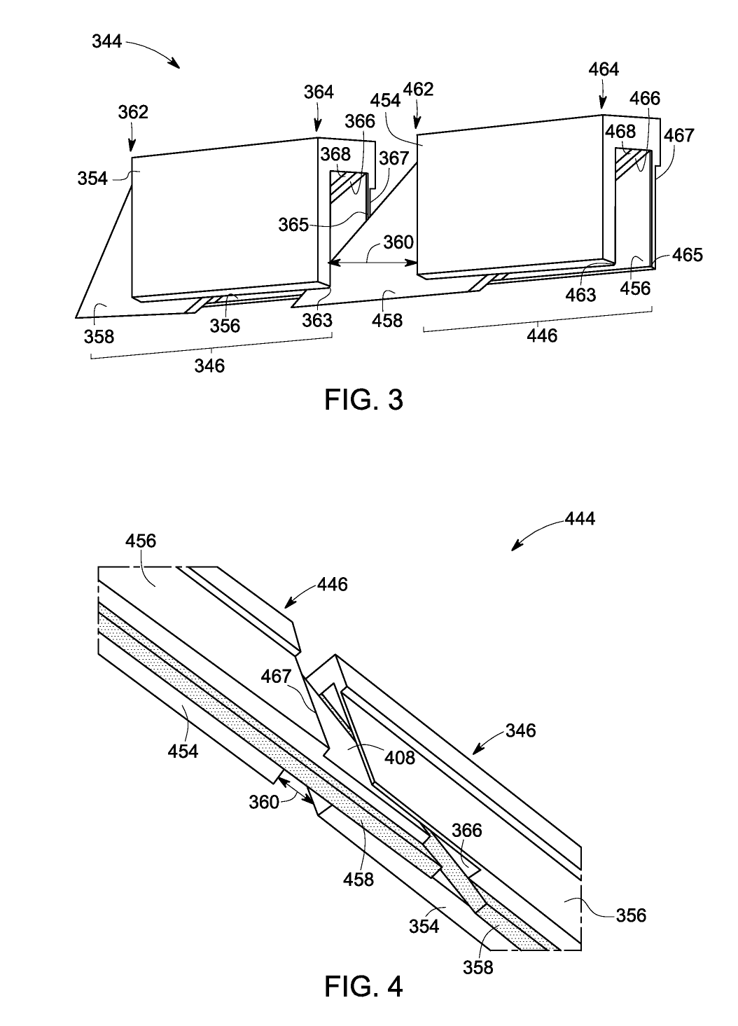

FIG. 1 is a cross-sectional view of an embodiment of a rotary machine 10 in accordance with an embodiment of the present invention. The rotary machine 10 includes a gas turbine with a variety of components, some of which are not shown for the sake of simplicity. In the illustrated embodiment, the rotary machine 10 includes a compressor section 12, a combustor section 14, and a turbine section 16. The turbine section 16 includes a stationary housing 18 and a rotating element 20, or rotor, which rotates about an axis 22. Moving blades 24 are attached to the rotating element 20 and stationary blades 26 are attached to the stationary housing 18. The moving blades 24 and stationary blades 26 are arranged alternately in the axial direction. The rotary machine also includes a seal assembly (as shown in FIGS. 2 and 3) having multiple sealing device segments disposed intermediate to the stationary housing 18 and the rotating element 20. There are several possible locations where the seal assembly may be installed. Non-limiting examples of such locations include a location 28 between a shrouded moving blade 24 and stationary housing 18, location 30 between the rotating element 20 and stationary blade 26, or an end-packing sealing location 32 between rotating element 20 and stationary housing 18. The seal assembly described herein provides a structure that enables the sealing device segments to move both radially and circumferentially and provide a tortuous path at inter-segment gaps, thereby potentially reducing leakage and increasing efficiency. The seal assembly described herein may be used with any suitable rotary machine, such as, but not limited to, the rotary machine 10 of FIG. 1 or any gas and steam turbines, compressors and aircraft engines.

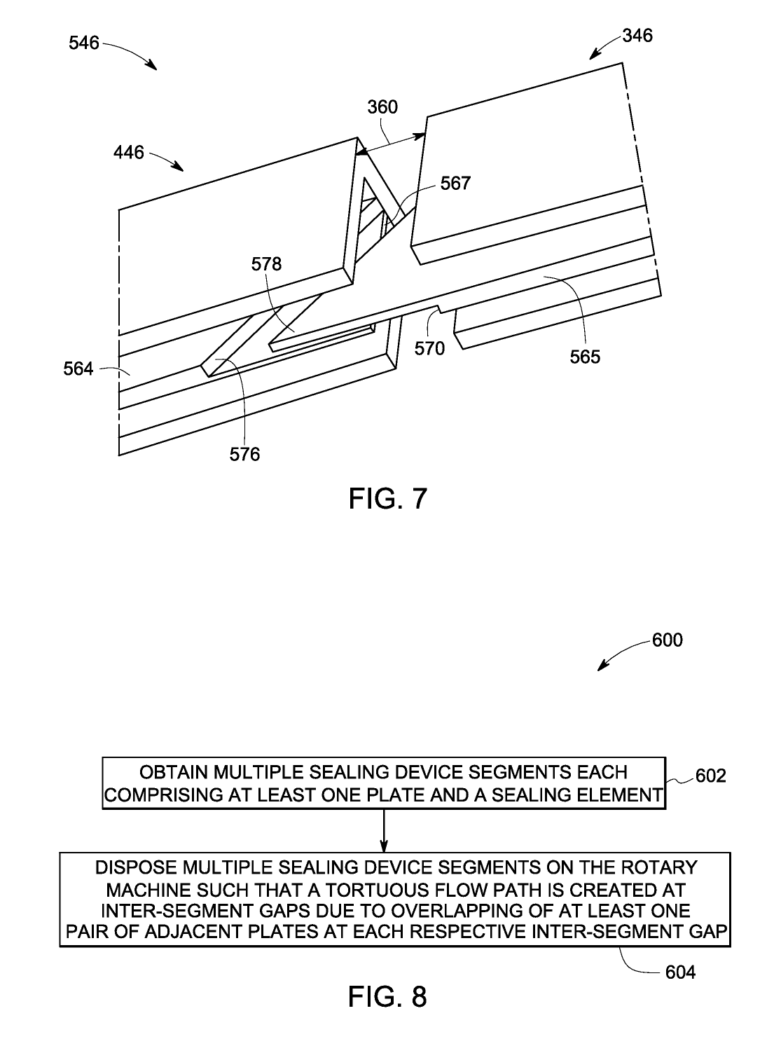

FIG. 2 is a cross-sectional view of the turbine section 216 of a rotary machine in accordance with an embodiment of the invention. In the illustrated embodiment, the turbine section 216 includes a rotating element 220 rotatable about an axis 222 and a stationary housing 240 comprised of upper and lower halves 241 and 242 respectively. The turbine section 216 includes a seal assembly 244 with multiple sealing device segments 246. Six sealing device segments 246 are shown in FIG. 2 for purposes of example only as other numbers of sealing device segments may be used. In the embodiment of FIG. 2, each of the sealing device segments 246 includes a sealing element located between front and back plates. As used herein, front plate means a flat plate disposed on one side of the sealing device segment 246 that is expected to be positioned on a higher pressure side of the seal assembly in operation, and back plate means a flat plate disposed on another side of the sealing device segment 246 that is expected to be positioned on a lower pressure side the seal assembly in operation. Although the front and back plates are described herein for purposes of illustration in FIGS. 3-5, the concepts are similarly applicable to embodiments with one plate or more than two plates per sealing device segment. If a sealing element other than a bristle pack is employed, such as labyrinth teeth or a honeycomb seal, one of the plates may be absent. Additionally, in some embodiments as shown in FIG. 6 and FIG. 7, a third or “intermediate” plate may be present. At the inter-segment gaps 248, at least one of the pair of front plates or the pair of back plates includes one plate overlapping another plate. In one embodiment, the sealing device segments 246 have arcuate sealing faces and may include chamfers (not shown in FIG. 2) at both ends of the sealing device segments 246 for ease of assembly of upper and lower halves 241 and 242 of the stationary housing 240. The chamfers are curved or flat surfaces at corners of the ends of both the front plates and back plates at the inter-segment gaps 248. The details of the seal assembly 244 are further discussed with respect to FIGS. 3, 4 and 5 below.

FIG. 3 shows a perspective view of an exemplary seal assembly 344 for facilitating reduction of axial leakage between the rotating element and the stationary housing shown in FIGS. 1, 2. The seal assembly 344 includes multiple sealing device segments 346 and 446 disposed intermediate to the stationary housing and the rotating element. Each of the sealing device segments includes a front plate 354, 454 a back plate 356, 456 and a sealing element (shown as element 358 for segment 346 and element 458 for segment 446) situated between the front plate and the back plate. Non-limiting examples of the sealing element 358, 458 include brush seals, labyrinth seals, leaf seals, shingle seals, honeycomb seals and abradable seals. Sealing device segments may further comprise actively or passively retractable segments. Further, the seal assembly 344 includes multiple inter-segment gaps 360 formed between the multiple sealing device segments 346, 446. In the illustrated embodiment, a pair of adjacent sealing device segments 346, 446 is shown to include the inter-segment gap 360. At least one of the pair of front plates 354, 454 or the pair of back plates 356, 456 includes one plate overlapping another plate at the inter-segment gap 360.

In one embodiment as shown in FIG. 3, the adjacent back plates 356, 456 overlap in an open seal position (high clearance position) and a closed seal position (low clearance position) during steady state operation of the rotary machine 10 (shown in FIG. 1). The overlapping of the adjacent back plates 356, 456 varies during different portions of the startup conditions, normal operating conditions, and shutdown conditions of the rotary machine as the segments move circumferentially towards and away from each other. As shown, the front plates 354, 454 and portions of the back plates 356, 456 include radially cut ends at both first ends 362, 462 and second ends 364, 464 of the sealing device segments 346, 446 in the region of inter segment gaps. At the one first end 462 of the sealing device segment 446, the back plate 456 further includes a first cant angle shaped profile (not shown) extending into the adjacent sealing device segment 346 and thus overlapping with the adjacent back plate 356 either in an open seal position during start up or a closed seal position during steady state operation of the rotary machine. At the second end 364 of the sealing device segment 346, the back plate 356 includes a second cant angle shaped profile 366 configured to accommodate the extended first cant angle shaped profile of adjacent overlapping back plate 456 of adjacent sealing device segment 446. The back plates 356, 456 of FIG. 3 also include radial cut end profiles 367, 467. The portion of the back plate 356, 456 having the first cant angle shaped profile and the second end shaped profile 366, 466 may additionally be configured to support the sealing element in one embodiment. A non-limiting example of the sealing elements 358, 458 may include a bristle pack which itself includes parallel cut ends 368, 468 and is aligned with the first cant angle shaped profiles and the second end shaped profiles 366, 466 of the adjacent sealing device segments. At the inter-segment gap 360, this arrangement of the front plates 354, 454, sealing elements 358, 458 and the overlapping back plates 356, 456 results in a tortuous path for flow leakage during start up or shutdown or during various operating conditions of the rotary machine (as shown in FIG. 1). If desired, an additional or alternative tortuous path may be formed by altering the front plates 354, 454 rather than leaving then flush as shown in FIG. 3. Furthermore, the front plates 354, 454 may include chamfers 363, 463 at corners of the front plates at the inter-segment gap 360. The chamfers 363, 463 are curved or flat surfaces for ease of assembly of the rotary machine. In one embodiment, the radial cut end profiles 367, 467 of the back plates 356, 456 also include chamfers 367, 467.

FIG. 4 shows another perspective view of a seal assembly 444 in a reverse orientation of FIG. 3 such that back plates 356 and 456 are in an outward facing position and additionally illustrates the two adjacent sealing elements 358, 458. The seal assembly 444 includes multiple sealing device segments 346, 446 with multiple inter-segment gaps 360. As shown, the back plate 456 includes the first cant angle shaped profile 408 that supports the sealing element 458 and extends into the adjacent sealing device segment 346. It is to be noted that the sealing element 458 in this embodiment includes parallel cut ends aligned with the first cant angle shaped profile 408 and the second end shaped profile 366 of the back plate 356. When the back plate 456 supports the sealing element 458 such that all cant angle shaped profiles of either the back plate 456 or the sealing element 458 have same inclination, interference between the adjacent sealing elements 458, 358 and the adjacent back plates 356, 456 is prevented. The sealing elements 458, 358 are fully supported at their ends by their own back plates 456 & 356 respectively. This feature is especially important in the case of actively or passively actuated seals, where the seal segments move radially inward & outward as well as move circumferentially towards and away from each other at the segment ends. As referenced above with respect to FIG. 3, in one embodiment, the front plates 354, 454 of the adjacent sealing device segments 346, 446 may be overlapping at the inter-segment gap 360 and may include similar features of the back plates 356, 456.

In this illustrated embodiment, the sealing device segments 346, 446 move freely in the radial direction as well as circumferential direction without interference at the inter-segment gaps 360 and simultaneously the overlapping of the back plates 356, 456 or the front plates 354, 454 is maintained under various operating conditions. This causes a tortuous path at the inter-segment gaps 360 for flow leakages and further results in higher pressure drop across the seal assembly 444. Furthermore, the higher pressure drop results in larger radial motion of the sealing device segments 346, 446 for same actuator stiffness. In one embodiment, the actuator of the sealing device segments 346, 446 includes a spring. Moreover, the higher-pressure drop causes the sealing device segments 346, 446 to close faster during the start up cycle for the same actuator stiffness allowing for efficient partial load operation of the rotary machine.

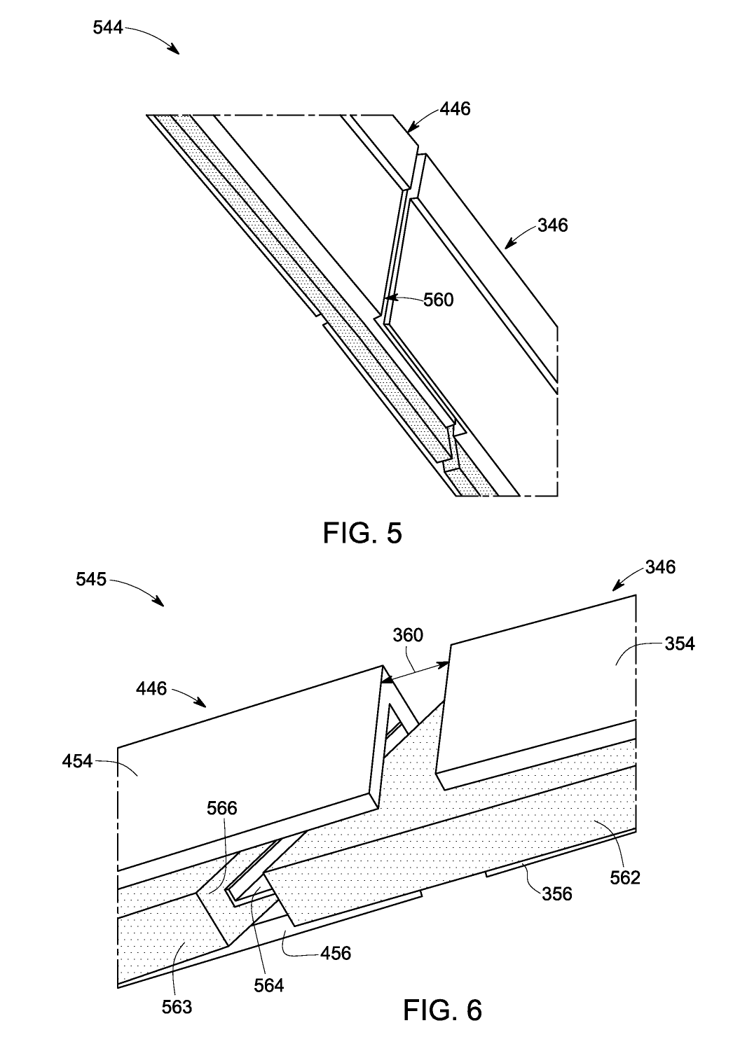

FIG. 5 shows another perspective view 544 of the seal assembly of FIGS. 3 and 4 in a closed seal position. As shown, in the closed seal position during a steady state operation of the rotary machine, the seal device segments 345, 446 have moved radially inward to a closed position, thereby, reducing the intersegment gaps 560 and the flow, due to the tortuous intersegment leakage path.

FIG. 6 is a perspective view of a seal assembly 545 of the rotary machine in accordance with another embodiment of the present invention. As shown, sealing elements 562 and 563 are situated in between the front plates 354, 454 and back plates 356, 456 of the sealing device segments 346 and 446 respectively. The sealing elements 562, 563 have cant angle shaped profiles 566 (shown for segment 446) at the inter-segment gap 360. In this embodiment, the seal assembly 545 includes an intermediate plate 564 situated between the front plates 354, 454 and back plates 356, 456 and remains seated within the sealing elements 562, 563. In one embodiment, the sealing element may be situated on either side or both sides of the intermediate plate 564 between the front plates 354, 454 and back plates 356, 456. FIG. 6 shows this intermediate plate 564 only in segment 446 but it is to be understood that the intermediate plate is present in every sealing device segment of the seal assembly. The cant angled shaped profiles of the sealing elements 562, 563 extend into the adjacent sealing device segments and are aligned with the cant angle shaped profiles of the intermediate plates 564.

FIG. 7 is a perspective view of a seal assembly 546 having the intermediate plates 564, 565 located in sealing device segments 446 and 346 respectively. The sealing elements 562, 563 (as shown in FIG. 6) have been omitted in FIG. 7 for highlighting the details of the intermediate plate 564. As shown, the intermediate plates 564, 565 include radial cut ends 567, 570 at the inter-segment gap 360. The intermediate plate 564 includes a first cant angle shaped profile 576 that is aligned with the cant angle shaped profile of the sealing element. The intermediate plate 565 also includes a second cant angle shaped profile 578 that supports the sealing element and extends into the adjacent sealing device segment 446. It is to be noted that the sealing elements (not shown) in this embodiment includes parallel cut ends aligned with the first cant angle shaped profile 576 and a second end shaped profile 578 of the back plate 356.

FIG. 8 is a flow chart of a method 600 of reducing leakage in a rotary machine in accordance with an embodiment of the invention. At step 602, the method 600 includes obtaining multiple sealing device segments, wherein each of the segments includes at least one plate and a sealing element. Finally at step 604, the method includes disposing the plurality of sealing device segments on the rotary machine such that a tortuous flow path is created at inter-segment gaps due to overlapping at least one pair of adjacent plates at each respective inter-segment gap. In one embodiment, the method includes obtaining the plurality of sealing device segments, wherein each of the segments includes a front plate, a back plate, and optionally an intermediate plate such that for pairs of adjacent sealing device segments, one or more pairs of back plates front plates or intermediate plates each comprises one plate overlapping another plate at the respective inter-segment gap. In one embodiment, the method also includes obtaining sealing device segments wherein one of the overlapping plates of the sealing device segment includes a first cant angle shaped profile extending into a first adjacent sealing device segment at a first inter-segment gap in an open seal position during start up and in a closed seal position during steady state operation of the rotary machine, and one of the overlapping plates of the sealing device segment comprises a second cant angle shaped profile configured to accommodate an extended first cant angle shaped profile of an overlapping plate of a second adjacent sealing device segment.

Advantageously, the present invention enables reduced leakages between the inter-segment gaps of the seal assembly in the rotary machine. The overlapping plates along with the sealing element at the inter-segment gaps create a tortuous path leading to reduced segment end gap leakage. This improves the efficiency and output of the rotary machine. Specifically, for a retractable brush seal, this helps in building up pressure drop at high clearance position of the sealing device segment allowing for faster seal closure (for same actuator stiffness) during start up, which can be essential for efficient partial load operation. The seal assembly can also be implemented both for passively and actively actuated brush seals as well as in fixed brush seals, whenever inter-segment leakage is significant such as typically the situation for large diameter (above 40 inches), many segment (more than 6) brush seals. Also, the disclosed seal assembly can better protect the sealing element (bristles) near the inter-segment gaps when the bristles of each sealing device segment are supported all the way to the end by its own back plate.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A seal assembly for a rotary machine, the seal assembly comprising:
a plurality of sealing device segments disposed intermediate to a stationary housing and a rotor, wherein each of the segments comprises at least one plate and a sealing element,
wherein a plurality of inter-segment gaps are formed between the plurality of sealing device segments,
wherein for pairs of adjacent sealing device segments, at least one of a pair adjacent plates comprises one plate overlapping another plate at a respective inter-segment gap.

2. The seal assembly of claim 1, wherein each of the segments comprises at least two plates and a sealing element situated between the at least two plates.

3. The seal assembly of claim 1, wherein each of the segments comprises a front plate, a back plate, and an intermediate plate, and wherein the plates comprise portions with radial cut ends at the inter-segment gaps.

4. The seal assembly of claim 1, wherein one of the overlapping plates of the sealing device segment comprises a first cant angle shaped profile extending into a first adjacent sealing device segment at a first inter-segment gap in an open seal position during start up and in a closed seal position during steady state operation of the rotary machine.

5. The seal assembly of claim 4, wherein one of the overlapping plates of the sealing device segment comprises a second cant angle shaped profile configured to accommodate an extended first cant angle shaped profile of an overlapping plate of a second adjacent sealing device segment.

6. The seal assembly of claim 5, wherein the sealing element comprises cant angle shaped profile ends configured to be aligned with both the first cant angle shaped profile and the second cant angle shaped profile of the overlapping plates.

7. The seal assembly of claim 1, wherein the sealing device segment comprises a retractable sealing device segment configured for both radial movement and circumferential movement at the inter-segment gaps.

8. The seal assembly of claim 3, wherein the overlapping plates comprise overlapping back plates.

9. The seal assembly of claim 3, wherein the overlapping plates comprise overlapping front plates.

10. The seal assembly of claim 3, wherein the overlapping plates comprise overlapping intermediate plates.

11. The seal assembly of claim 1, wherein the sealing elements comprise brush seals, labyrinth seals, leaf seals, shingle seals, honeycomb seals, or abradable seals.

12. The seal assembly of claim 1, wherein the sealing device segment comprises one of an actuated brush seal segment or a stationary brush seal segment.

13. A method of reducing leakage in a rotary machine, the method comprising:
obtaining a plurality of sealing device segments, wherein each of the segments comprises at least one plate and a sealing element; and
disposing the plurality of sealing device segments on the rotary machine such that a tortuous flow path is created at inter-segment gaps due to overlapping of at least one pair adjacent plates at each respective inter-segment gap.

14. The method of claim 13, wherein obtaining the plurality of sealing device segments comprises obtaining a plurality of segments each comprising a front plate, a back plate, and optionally an intermediate plate such that for pairs of adjacent sealing device segments, at least one of the pair of back plates, the pair of front plates, or the optional pair of intermediate plates comprises one plate overlapping another plate at the respective inter-segment gap.

15. The method of claim 13, further comprising obtaining sealing device segments wherein one of the overlapping plates of the sealing device segment comprises a first cant angle shaped profile extending into a first adjacent sealing device segment at a first inter-segment gap in an open seal position during start up and in a closed seal position during steady state operation of the rotary machine, and wherein the one of the overlapping plates of the sealing device segment comprises a second cant angle shaped profile configured to accommodate an extended first cant angle shaped profile of an overlapping plate of a second adjacent sealing device segment.

16. The method of claim 15, further comprising obtaining sealing elements with cant angle shaped profile ends configured to be aligned with both the first cant angle shaped profile and the second cant angle shaped profile of the overlapping plates.

17. A rotary machine, comprising:
a stationary housing extending circumferentially around a rotor rotatable about an axis;
a seal assembly comprising a plurality of sealing device segments disposed intermediate to the stationary housing and the rotor, wherein each of the segments comprises at least one plate and a sealing element,
wherein a plurality of inter-segment gaps are formed between the plurality of sealing device segments,
wherein for pairs of adjacent sealing device segments, at least one of a pair adjacent plates comprises one plate overlapping another plate at a respective inter-segment gap.

18. The machine of claim 17, further comprising a chamfer at a first end of the at least one plate of each of the sealing device segments at the inter-segment gap, and
a chamfer at a second end of the at least one plate of each of the sealing device segments at the inter-segment end gap.

19. The machine of claim 17, wherein the sealing elements comprise brush seals, labyrinth seals, leaf seals, shingle seals, or honeycomb seals.
